(19) United States
(12) Patent Application Publication
(10) Pub. No.: US 2016/0150432 A1
(43) Pub. Date: May 26, 2016

(54) WIRELESS COMMUNICATIONS METHOD AND WIRELESS COMMUNICATIONS DEVICE

(71) Applicants: Zhongbin QIN, Beijing (CN); SONY CORPORATION, Tokyo (JP)

(72) Inventor: Zhongbin QIN, Beijing (CN)

(73) Assignee: SONY CORPORATION, Tokyo (JP)

(21) Appl. No.: 14/888,001

(22) PCT Filed: Jun. 3, 2014
(86) PCT No.: PCT/CN14/79063

§ 371 Date: Oct. 29, 2015

(30) Foreign Application Priority Data
Jun. 6, 2013 (CN) 201310222585.7

(51) Int. Cl. H04W 24/10; H04B 17/309; H04W 64/00; H04W 24/08

(52) U.S. Cl. CPC H04W 24/10; H04W 24/08; H04B 17/309; H04W 64/00

(57) ABSTRACT

A wireless communication method and wireless communication apparatus allowing triggering of inter-frequency measurement. The method and apparatus are used in a heterogeneous network including a first base station and a second base station with different transmission power levels. The wireless communications method includes: receiving a measurement value of a signal received by a terminal as a first measurement value, or receiving a measurement value of a signal received by a second base station from the terminal as a second measurement value; determining a first/second measurement reference value of a statistic value of quality information associated with a location of the terminal and corresponding to the first/second measurement value; comparing the first/second measurement value with the first/second measurement reference value; and triggering an inter-frequency measurement of the terminal according to a relationship of a predetermined offset amount and an offset of the first/second measurement value from the first/second measurement reference value.

### TECHNICAL FIELD

The disclosure relates generally to the field of wireless communications, and particularly to a wireless communication method and a wireless communication apparatus allowing triggering of inter-frequency measurement.

### BACKGROUND ART

The concept of heterogeneous network was proposed earliest in 3GPP Rel-10, and it became one of focuses in the art rapidly. Mobility enhancement in the heterogeneous network is one of research projects in the art, aiming to improve the capacity of the network while providing seamless and stable coverage for a user.

Mobility enhancement in the heterogeneous network discusses many problems, wherein inter-frequency measurement for small cell discovery is one of focuses discussed by 3GPP. A large number of small cells, such as micro base stations, femto base stations, home base stations, radio remote units and so on, are included in the heterogeneous network, and they are mainly distributed in places such as homes, offices, shopping centers and so on. By switching a user to a small cell, the burden of a macro base station is reduced while improving the capacity of the network.

However, the introduction of the concept of heterogeneous network also causes many problems. For example, current neighboring cell discovery mechanism aims to ensure the mobility of mobile terminals (UEs), without considering new deployment environment in the heterogeneous network. Also for example, small cell discovery strategy generally requires use of measurement gaps to perform inter-frequency measurement. For mobile terminals, frequently configuring measurement gaps will not only consume power but also occupy available resources greatly.

In 3GPP TR 36.839, there are the following conventional types of inter-frequency measurement:

a) Relaxed Measurement Configuration

According to the type of a small cell (serving as a access point or providing coverage) and the speed of a mobile terminal, a measurement period is increased to reduce unnecessary measurement, without allowing a high-speed mobile terminal to access a small cell in the access point. The scheme reduces power consumption at the mobile terminal side and interference upon a service cell user plane; however, the scheme results in poor precision and causes presence of a discovery time delay.

b) Proximity Based Small Cell Indication

Inter-frequency measurement may be triggered based on Proximity Indication, and the schemes may be classified as being macro-base-station-based, small-cell-based, or mobile-terminal-based. The macro-base-station-based scheme and the small-cell-based scheme make no modification on the user plane, but involve a biggest problem concerning how to improve precision. In addition, the small-cell-based scheme requires modification of X2 interface. However, the mobile-terminal-based scheme is more precise and has higher feasibility, but would bring complexity to the mobile terminal side.

### SUMMARY OF THE INVENTION

Considering the aforementioned disadvantages existing in the prior art, an object of the invention is to provide a wireless communication method and a wireless communication apparatus which perform, according to a measurement result of a downlink and/or uplink service frequency band(s), determination of triggering of inter-frequency measurement of a higher frequency band.

According to one aspect of the disclosure, there is provided a wireless communication method allowing triggering of inter-frequency measurement, for use in a heterogeneous network comprising a first base station and a second base station with different transmission power levels. The wireless communication method comprises: receiving a measurement value of a signal received by a terminal as a first measurement value, or receiving a measurement value of a signal received by the second base station from the terminal as a second measurement value; determining a first/second measurement reference value of a statistic value of quality information which is associated with a location of the terminal and is corresponding to the first/second measurement value; comparing the first/second measurement value with the first/second measurement reference value; and triggering inter-frequency measurement of the terminal according to a relationship of a predetermined offset amount and an offset of the first/second measurement value from the first/second measurement reference value.

According to another aspect of the disclosure, there is provided a wireless communication apparatus, for use in a heterogeneous network comprising a first base station and a second base station with different transmission power levels. The wireless communication apparatus comprises: a receiving unit, for receiving a measurement value of a signal received by a terminal as a first measurement value, or receiving a measurement value of a signal received by the second base station from the terminal as a second measurement value; a determining unit, for determining, as a first/second measurement reference value, a statistic value of quality information which is associated with a location of the terminal and is corresponding to the first/second measurement value; a comparing unit, for comparing the first/second measurement value with the first/second measurement reference value; and a triggering unit, for triggering inter-frequency measurement of the terminal according to a relationship of a predetermined offset amount and an offset of the first/second measurement value from the first/second measurement reference value.

According to another aspect of the disclosure, there is provided a wireless communication apparatus, comprising: a measuring unit, for acquiring a measurement value of a signal received from a non-service terminal; and a feedback unit, for providing the measurement value and information associated with the measurement value to a service base station of the non-service terminal.

By implementing the wireless communication method and wireless communication apparatus according to the disclosure, it is possible to start inter-frequency measurement by means of conditional triggering, without setting an inter-frequency measurement period, thereby saving power consumption of a mobile terminal for inter-frequency measurement and ensuring that inter-frequency diffluence of a service is performed timely.

In addition, according to another aspect of the disclosure, there is further provided a storage medium comprising machine-readable program code, wherein when the program code is executed in an information processing apparatus or a wireless communication apparatus, the program code makes the information processing apparatus or the wireless communication apparatus carry out the aforementioned method according to the invention.

Besides, according to a further aspect of the invention, there is further provided a program product comprising machine-executable instructions, wherein when the instructions are executed in an information processing apparatus or a wireless communication apparatus, the instructions make the information processing apparatus or the wireless communication apparatus carry out the aforementioned method according to the invention.

### BRIEF DESCRIPTION OF THE DRAWINGS

The foregoing and other objects, features and advantages of the invention would be understood more easily with reference to the following descriptions of the embodiments of the invention combined with the accompanying drawings. In the accompanying drawings, identical or corresponding technical features or components will be denoted by identical or corresponding reference signs. In the accompanying drawings, sizes and relative positions of units are not necessarily plotted in scale.

FIG. 1 is a schematic view illustrating an application scene of a heterogeneous network according to the disclosure.

FIG. 2 is a flow chart illustrating a wireless communication method for determining a triggering time of inter-frequency measurement from a measurement value of a receiving signal of a mobile terminal according to the disclosure.

FIG. 3 is a flow chart illustrating the flow of acquiring quality information required for determining a first measurement reference value according to an embodiment of the disclosure.

FIG. 4 is a flow chart illustrating the flow of determining the start of the determination of the first measurement reference value according to an embodiment of the disclosure.

FIG. 5 is a flow chart illustrating a wireless communication method for determining a triggering time of inter-frequency measurement from a measurement value of a signal received from a mobile terminal according to an embodiment of the disclosure.

FIG. 5A is a schematic view illustrating a measurement value of a signal received by a small cell base station from a mobile terminal.

FIG. 6 is a timing diagram illustrating a specific example of the method as shown in FIG. 5 according to an embodiment of the disclosure.

FIG. 7 is a timing diagram illustrating another example of the method as shown in FIG. 5 according to an embodiment of the disclosure.

FIG. 8 is a timing diagram illustrating yet another example of the method as shown in FIG. 5 according to an embodiment of the disclosure.

FIG. 9 is a function structural block diagram illustrating the wireless communication apparatus according to an embodiment of the disclosure.

FIG. 10 is a function structural block diagram illustrating the wireless communication apparatus according to an embodiment of the disclosure.

FIG. 11 is a schematic block diagram that can be used for implementing the wireless communication apparatus according to an embodiment of the invention.

### DETAILED DESCRIPTION OF THE EMBODIMENTS

Hereinafter, the embodiments of the invention will be described with reference to the accompanying drawings. It should be noted that, for the sake of clarity, representations and descriptions of components and process known to those ordinarily skilled in the art which are irrelevant to the invention will be omitted in the accompanying drawings and the descriptions.

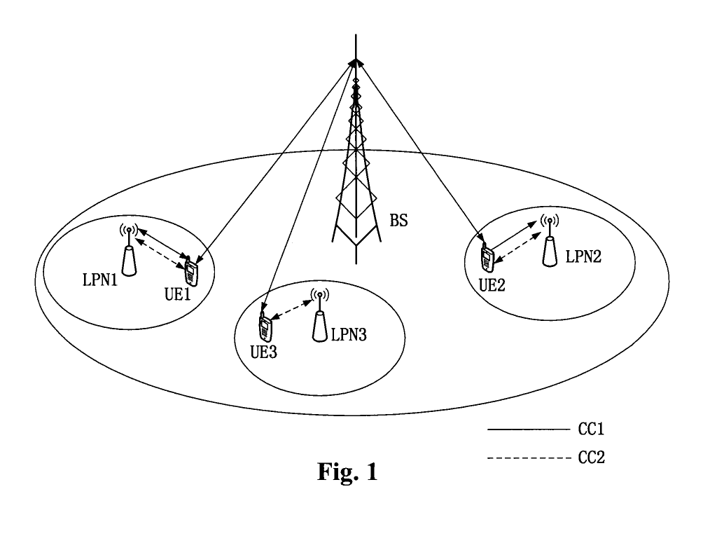

Firstly, referring to FIG. 1, an application scene of the wireless communication method and apparatus according to the disclosure in a heterogeneous network is described. FIG. 1 is a schematic view illustrating an application scene of a heterogeneous network according to the disclosure.

In FIG. 1, BS is a macro base station, which is also referred to as a first base station hereinafter. A service carrier of the macro base station is CC1. LPN1, LPN2 and LPN3 are low power nodes in the heterogeneous network with different function levels from the macro base station, such as remote radio heads, small cell base stations and so on, and they are also referred to as second base stations hereinafter and are uniformly referred to as LPNs when they are not necessarily distinguished. Besides CC1, the LPNs can also use a high-frequency carrier CC2 to perform data transmission. UE1, UE2 and UE3 are mobile terminals using the network, and are uniformly referred to as UEs hereinafter when they are not necessarily distinguished. As shown in FIG. 1, solid-line arrows represent data transmission of the component carrier 1 (CC1); and broken-line arrows represent transmission of the component carrier 2 (CC2). For the sake of convenience, only the component carriers 1 and 2 are shown herein. In actual data transmission, all the macro base station BS and the low power nodes would possibly use service carriers of different frequency bands, and the service carriers thereof may be at the same frequency point or at different frequency points.

FIG. 1 schematically illustrates three operating scenes of the low power nodes LPNs according to the invention: I. for example, the low power node LPN1 transmits downlink signals and receives uplink signals on both the component carriers CC1 and CC2; II. for example, the low power node LPN2 transmits a downlink signal and receives an uplink signal on the component carrier CC2, and only performs reception of an uplink signal on the component carrier CC1; and III. for example, the low power node LPN3 transmits a downlink signal and receives an uplink signal on the component carrier CC2, but does not operate on the component carrier CC1.

The wireless communication method according to the disclosure can be implemented at least in the following three manners according to different operating scenes: 1. performing determination of triggering of CC2 inter-frequency measurement according to a measurement result of the downlink CC1 frequency band; 2. performing determination of triggering of CC2 inter-frequency measurement according to a measurement result of the uplink CC1 frequency band; or 3. performing determination of triggering of CC2 inter-frequency measurement according to not only a measurement result of the downlink CC1 frequency band but also a measurement result of the uplink CC1 frequency band. Hereinafter, the three manners will be described in detail respectively.

Determination Based on CC1 Downlink Measurement Result

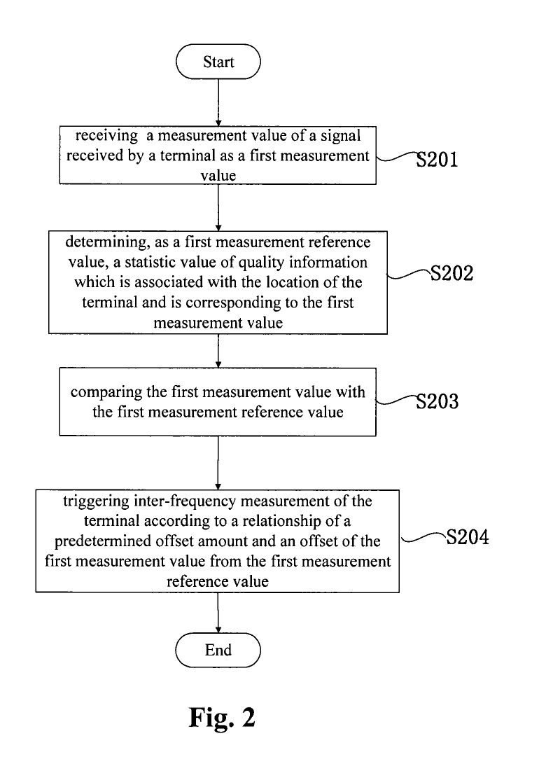

Firstly, the manner of performing determination of triggering of CC2 inter-frequency measurement according to a measurement result of the downlink CC1 frequency band will be described. FIG. 2 is a flow chart illustrating a wireless communication method for determining a triggering time of inter-frequency measurement from a measurement value of a receiving signal of a mobile terminal according to the disclosure.

As shown in FIG. 2, in step S201, a measurement value of a receiving signal of the terminal UE is received. Specifically, a measurement value of a receiving signal of the terminal UE which is related to a downlink signal on the service carrier of the macro base station is received. For the sake of convenience, the measurement value is referred to as a first measurement value hereinafter. The first measurement value may be at least one of quality information of the receiving signal of the mobile terminal which is known in the art. For example, the measurement value of the receiving signal of the mobile terminal may at least comprise one of reference signal receiving power (RSRP), reference signal receiving quality (RSRQ), reference signal strength indication (RSSI), channel quality/channel state indication (CQI/CSI), reference signal receiving power based on the channel quality/channel state indication, and reference signal receiving quality based on the channel quality/channel state indication.

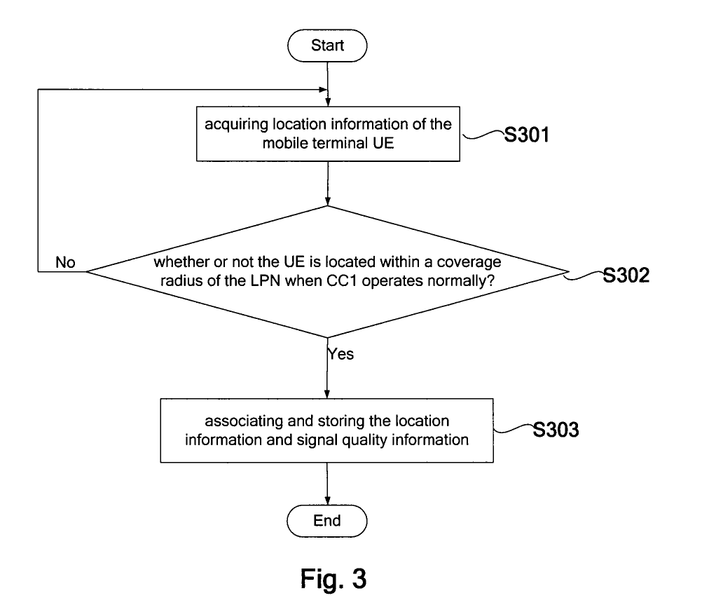

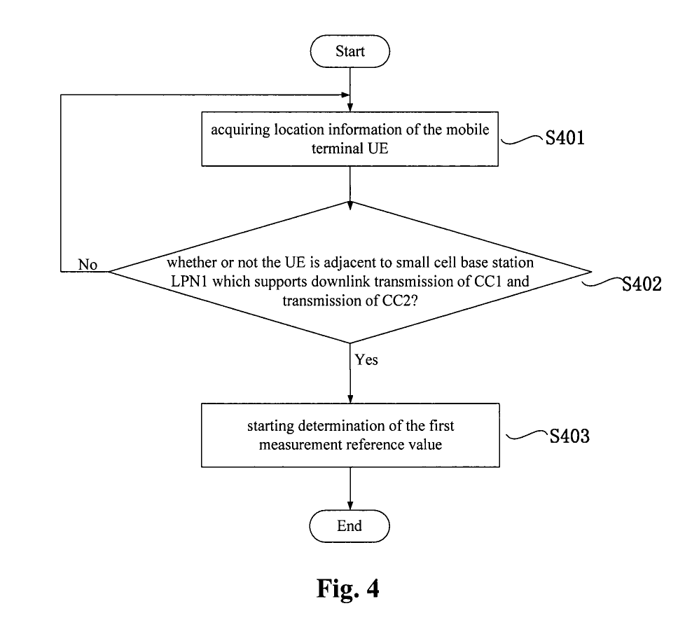

In step S202, a statistic value such as a statistic average value and so on of quality information which is associated with the location of the terminal and is corresponding to the first measurement value is determined. For the sake of convenience, the statistic value or the statistic average value is referred to as a first measurement reference value hereinafter. One of the manners of determining the first measurement reference value will be exemplarily described below in combination with FIGS. 3 and 4.

Considering that the first measurement reference value is desired to be an average of statistic values of quality of transmission signals on the CC1 received by the mobile terminal UE at a specific location, in a homogeneous network, i.e., in the absence of downlink transmission (signal interference or enhancement) of the low power node (small cell base station) LPN1 on the service carrier CC1 of the macro base station BS, quality information required for determining the first measurement reference value which is associated with the location of the terminal and is corresponding to the first measurement value (a sampling value of downlink signal quality, or referred to as a statistic value of signal quality) may be acquired in a case where the small cell base station LPN1 performs no downlink transmission on the CC1, for example in a case where the LPN1 is closed (also equivalent to in the case of the LPN3 mentioned in context, which will not be specifically distinguished in context unless where necessary), or in a case where the small cell base station LPN1 only performs uplink reception on the service frequency band CC1 of the terminal UE without performing downlink transmission (also equivalent to in the case of the LPN2 mentioned in context, which will not be specifically distinguished in context unless where necessary). For example, when the first measurement value is reference signal receiving power (RSRP), the quality information required for determining the first measurement reference value is a sampled value (or referred to as a statistic value) of reference signal receiving power of the terminal at a specific location, when the downlink transmission of the small cell base station LPN1 on the CC1 is closed.

In actual application, in the case of a lighter load of the network, the network will close transmission of the low power node LPN1 on the CC1 for the purpose of saving energy. In this case, a data transmission requirement of a user may be satisfied by allocating more resources of the CC1 to the macro base station. At this time, a statistic value of signal quality may be acquired for the mobile terminal at a specific location. FIG. 3 is a flow chart illustrating the flow of acquiring quality information required for determining a first measurement reference value according to an embodiment of the disclosure. During the closing of the low power node LPN1 (LPN3) or the closing of its downlink transmission on the CC1 (LPN2), the process as shown in FIG. 3 is performed.

In step S301, location information of the mobile terminal is acquired. The location information of the mobile terminal may be acquired using various known methods. For example, the location of the mobile terminal may be determined using a global positioning system (GPS). Or, for example, an approximate location of the mobile terminal is determined according to an arrival angle and a time advance amount of uplink data of the mobile terminal.

In step S302, it is determined based on the location information of the mobile terminal UE whether or not the mobile terminal UE is located near (e.g. 50 meters) a coverage/interference radius of the small cell base station LPN1 during normal operation of the CC1 downlink transmission. The coverage/interference radius can be obtained through pre-storage or pre-estimation. If the mobile terminal UE is not near the coverage/interference radius (“NO” in step S302), the process returns to step S301 to acquire the location information of the mobile terminal UE again. If the mobile terminal UE is near the coverage/interference radius (“YES” in step S302), the process proceeds to step S303.

In step S303, the substantial location information of the mobile terminal UE is associated with the statistic value of signal quality related to the first measurement value, and the association information is stored, thereby completing acquisition of the statistic value of signal quality for acquiring the first measurement reference signal.

For the scenes of the LPN2 and the LPN3, the mobile terminal UE will not be interfered by the LPN when receiving the downlink signal of the macro base station, so a statistic value of signal quality acquired and stored by the mobile terminal UE at a location very close to the LPN (e.g. a coverage edge of the LPN) may be used as the first measurement reference value. For the scene of the LPN1, however, due to interference produced by the downlink transmission of the small cell base station LPN1 on the CC1 to the downlink transmission of the macro base station BS on the CC1, the first measurement reference value shall be obtained from a statistic value of signal quality acquired in advance according to the flow as shown in FIG. 3.

Hereinafter, how to obtain the first measurement reference value using the statistic value of signal quality acquired in advance will be described in combination with FIG. 4. In a case where it is desired to determine whether or not to trigger CC2 inter-frequency measurement using the interference produced by the downlink transmission of the small cell base station LPN1 on the CC1 to the downlink transmission of the macro base station BS on the CC1, the determination of the first measurement reference value may be initiated in response to a specific condition. For example, the determination of the first measurement reference value may be initiated in response to the fact that mobile terminal UE is close to the small cell of the LPN1.

FIG. 4 is a flow chart illustrating the determination of the first measurement reference value in response to the fact that the location of the mobile terminal UE is adjacent to the small cell according to an embodiment of the disclosure.

Specifically, in step S401, location information of the mobile terminal is acquired. The location information of the mobile terminal may be acquired using various known methods. For example, the mobile terminal is positioned using a GPS. Or, for example, an approximate location of the mobile terminal is determined according to an arrival angle and a time advance amount of uplink data of the mobile terminal.

In step S402, it is determined, according to the location information of the mobile terminal UE, whether or not the mobile terminal UE is adjacent to the small cell base station LPN1 which can support the downlink transmission of the service frequency band CC1 and the transmission of the other frequency band CC2. Herein, the location information of the small cell base station LPN1 is known in advance. In a case where the mobile terminal UE is not adjacent to the small cell base station LPN1 (“NO” in step S402), the process returns to step S401 to acquire the location information of the mobile terminal UE again, so as to perform the process repeatedly. In a case where the mobile terminal UE (UE1 herein) is adjacent to the small cell base station LPN1 (“YES” in step S402), the process proceeds to step S403.

In step S403, the first measurement reference value is determined according to a current location of the mobile terminal UE. For example, referring to the example as shown in FIG. 3, in a case where the association information between the location of the mobile terminal UE and the statistic value of quality of received information on the CC1 is stored in advance, a statistic value of quality corresponding to the current location of the UE may be read as the first measurement reference value. Of course, an average value of all statistic values of quality may also be calculated as the first measurement reference value. Or, an average value of all statistic values of quality obtained in advance through calculation may be read directly as the first measurement reference value.

Returning to FIG. 2, in step S203, the acquired first measurement value is compared with the first measurement reference value, so as to determine an offset amount between the first measurement value and the first measurement reference value. In step S204, it is determined, according to a relationship of a predetermined offset amount and the offset amount between the first measurement value and the first measurement reference value, whether or not to trigger inter-frequency measurement of the terminal.

For the scenes of the LPN2 and the LPN3, even if the mobile terminal UE will not be interfered by the LPN when receiving the downlink signal of the macro base station, the strength of the downlink signal received by the mobile terminal UE still will change as its location varies. In this case, the first measurement value may be compared with the statistic value of signal quality acquired and stored by the mobile terminal UE at a location very close to the LPN (e.g. a coverage edge of the LPN), i.e. the first measurement reference value. When the offset of the actual first measurement value with respect to the first measurement reference value is not large, it is regarded that the terminal is very adjacent to the LPN such that inter-frequency measurement can be triggered. That is, inter-frequency measurement of the terminal is triggered when the first measurement value is higher or lower than the first measurement reference value by an amount less than a predetermined offset amount.

For the scene of the LPN1, in a case where the small cell base station LPN1 and the macro base station BS transmit downlink signals on the same frequency band, a receiving signal of the mobile terminal UE adjacent to the LPN1 will be influenced. For example, when cell identifiers of downlink signal sequences transmitted by a small cell of the LPN1 and a macro cell of the BS on the same frequency band CC1 are the same, a receiving signal of the mobile terminal UE will be enhanced; while when cell identifiers of downlink signal sequences transmitted by a small cell of the LPN1 and a macro cell of the BS on the same frequency band CC1 are different, a receiving signal of the mobile terminal UE will be weakened. Based upon this phenomenon, it can be determined, by comparing a statistic value of a receiving signal of the mobile terminal UE at a specific location with a statistic value of a receiving signal of the mobile terminal UE at the location in the absence of downlink signals on the frequency band CC1 other those from the macro base station BS, whether or not a small cell base station LPN1 performing downlink transmission using the frequency band CC1 exists near the mobile terminal UE, thereby determining whether or not to trigger inter-frequency measurement of the mobile terminal UE.

In one example, for example, when cell identifiers of downlink signal sequences transmitted by a small cell and a macro cell on the frequency band CC1 are the same, inter-frequency measurement of the terminal is triggered when the first measurement value is higher than the first measurement reference value by above the predetermined offset amount.

In another example, for example, when cell identifiers of downlink signal sequences transmitted by a small cell and a macro cell on the frequency band CC1 are different, inter-frequency measurement of the terminal is triggered when the first measurement value is lower than the first measurement reference value by above the predetermined offset amount.

Note that, the predetermined offset amount may be determined based on an inter-frequency measurement triggering target accuracy rate, which is a probability that an inter-frequency small cell signal strength detected after the triggering of the inter-frequency measurement is higher than a particular target threshold value (hereinafter referred to as “a first target threshold value”). In other words, the setting of the predetermined offset amount shall ensure that the detected inter-frequency cell signal strength is high enough after inter-frequency measurement is triggered.

In the foregoing embodiments, inter-frequency measurement is triggered when the predetermined offset amount and the offset amount between the first measurement value and the first measurement reference value satisfy the predetermined relationship. It should be understood that a predetermined condition may also be further set, such that inter-frequency measurement is triggered only when the offset of the first measurement value with respect to the first measurement reference value satisfies the predetermined condition. The predetermined condition may comprise at least one of a duration in which the offset amount between the first measurement value and the first measurement reference value and the predetermined offset amount satisfy the predetermined relationship is longer than a predetermined time length, or a frequency of occurrence of satisfying the predetermined relationship within a predetermined period of time is greater than a predetermined number of times or percentage. Similarly, the predetermined condition may also be determined based on an inter-frequency measurement triggering target accuracy rate, which is a probability that an inter-frequency small cell signal strength detected after the triggering of the inter-frequency measurement is higher than a second target threshold value, wherein the second target threshold may be the same as or different from the first target threshold.

The foregoing descriptions are made as to determining timing of triggering CC2 measurement based on a CC1 downlink measurement result. Hereinafter, descriptions will be made as to determining timing of triggering CC2 measurement based on a CC1 uplink measurement result.

Determination Based on CC1 Uplink Measurement Result

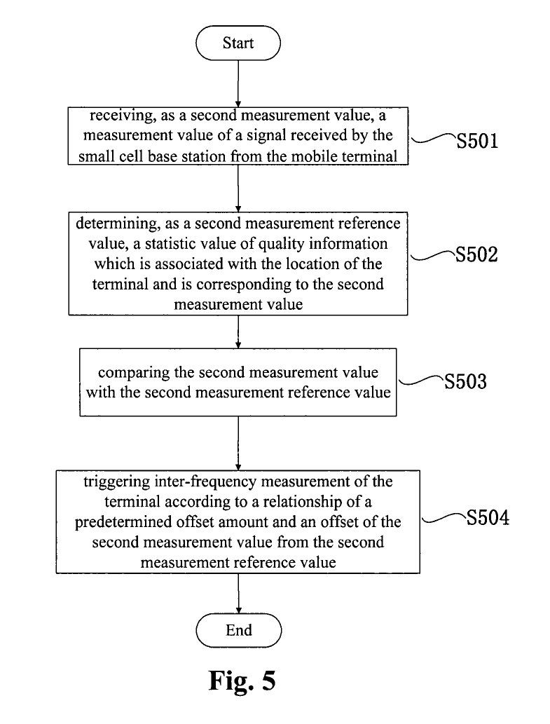

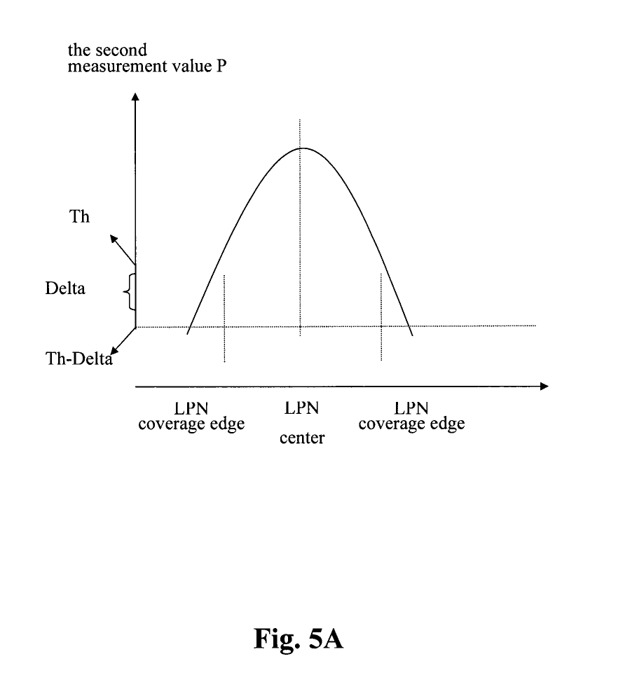

Performing triggering of the CC2 inter-frequency measurement based on the measurement result of the uplink signal on the CC1 frequency band indeed applies to the scenes of small cell base stations transmitting uplink signals on the component carrier CC1, such as the scenes of the LPN1 and the LPN2. FIG. 5A is a schematic view illustrating a measurement value of a signal received by a small cell base station from a mobile terminal.

As shown in FIG. 5, in step S501, a measurement value of a signal received by a small cell base station from a mobile terminal is received. For the sake of convenience, the measurement value is referred to as a second measurement value hereinafter. The second measurement value may be the signal strength of at least one of signals received by the small cell base station from the component carrier CC1 of the mobile terminal which are known in the art. For example, the second measurement value may comprise the signal strength of at least one of an uplink sounding reference signal (SRS) received by the small cell base station on the CC1, a physical uplink control channel signal (PUCCH) and a physical uplink shared channel signal (PUSCH).

In step S502, a statistic average value of quality information which is associated with the location of the terminal and is corresponding to the second measurement value is determined. For the sake of convenience, the statistic average value is referred to as a second measurement reference value hereinafter.

In one example, a statistic value or a statistic average value of the signal strength of at least one of the uplink sounding reference signal, the physical uplink control channel signal and the physical uplink share channel signal of the terminal located at a coverage radius edge of the small cell base station LPN on the component carriers CC1 may be determined, as the second measurement reference value, in correspondence to the second measurement value. For example, when the acquired second measurement value is the uplink sounding reference signal (SRS) received by the small cell base station LPN on the CC1, the second measurement reference value may be a statistic value or a statistic average value of the signal strength of the uplink sounding reference signal of the terminal which is located at a coverage radius edge of the component carriers CC1 of the small cell base station LPN.

In step S503, the second measurement value is compared with the second measurement reference value to determine the offset amount of the second measurement value from the second measurement reference value.

Next, in Step S504, it is determined, based on the relationship of the predetermined offset amount and the offset amount between the second measurement value and the second measurement reference value, according to the location information of the UE in the first base station, whether the UE is adjacent to a coverage area of the low power nodes, so as to determine whether or not to trigger inter-frequency measurement of the terminal.

In the foregoing case of performing determination based on a downlink measurement result of CC1, the downlink signals will be enhanced or weakened (depending on cell IDs) since the two different base stations, i.e. the macro base station BS and the small cell base station LPN, transmit signals of the same frequency. Rather, for the case of performing determination based on an uplink measurement result of CC1 as described herein, in the uplink signals, no enhancement or weakening of the uplink signals will occur due to the presence of only one transmission node, i.e. the mobile terminal UE. Thus in this case, a distance between the mobile terminal UE and the small cell base station LPN shall be mainly considered to decide whether or not to start inter-frequency measurement. When the mobile terminal UE becomes closer to the small cell base station LPN, it is more necessary to start inter-frequency measurement.

Actually, at locations where the distances from the mobile terminal UE to the LPN are different, the second measurement values of the uplink signals on the CC1 which are received by the LPN from the mobile terminal UE are different; generally, the second measurement value is larger when the UE becomes closer to the LPN, as shown in FIG. 5A. As described above, the second measurement reference value may be determined based on the signal strength of the uplink signal of the terminal which is located at a coverage radius edge of the small cell base station LPN on the component carriers CC1. When the actual second measurement value is greater than the second measurement reference value, or is less than the second measurement reference value but its offset from the second measurement reference value is within a predetermined offset amount range, it is indicated that the UE is within the coverage range of the LPN, or has not yet entered but is very close to the coverage edge of the LPN, and this case is suitable for triggering inter-frequency measurement. Thus, in a case where the second measurement value P is greater than the second measurement reference value Th minus the predetermined offset amount Delta, i.e. in a case where P>Th−Delta, inter-frequency measurement of the terminal may be triggered. In other words, inter-frequency measurement of the terminal is triggered when the offset of the second measurement value from the second measurement reference value satisfies the predetermined offset amount relationship (Th−P<Delta).

In addition, it should also be noted that triggering inter-frequency measurement according to the above determination condition would possibly trigger inter-frequency measurement when the mobile terminal is still far from the LPN. For example, when transmission power of the mobile terminal UE is very large, although the mobile terminal UE is very far from the LPN, a case where the predetermined offset amount and the offset amount between the second measurement value and the second measurement reference value satisfy the above relationship still would possibly occur. In this case, inter-frequency measurement of the terminal may be triggered according to an uplink path loss. Specifically, inter-frequency measurement of the terminal may be triggered according to a relationship between an uplink path loss estimated from the signal received by the LPN from the mobile terminal UE and a statistic value of an uplink path loss of an edge terminal user of the LPN. Generally, the uplink path loss of the UE is lower when the UE is closer to the LPN, so when the uplink path loss of the UE is lower than the statistic value of the uplink path loss of the edge terminal user of the LPN, or is higher than but very approximate to the statistic value of the uplink path loss, the UE would possibly be within or near the coverage area of the LPN, so it is suitable to trigger inter-frequency measurement. Specifically, when it is satisfied that the uplink path loss of the UE is lower than the statistic value of the uplink path loss of the edge terminal user of the LPN plus the predetermined offset amount, inter-frequency measurement of the terminal may be triggered. Thus, the scheme of triggering inter-frequency measurement while considering the uplink path loss of the UE may be adopted in combination with the foregoing scheme of triggering inter-frequency measurement according to the second measurement value, so as to improve the accuracy of triggering and save the power consumption of the UE. It should be noted that the scheme of triggering inter-frequency measurement according to the uplink path loss may also be adopted individually to reduce the complexity of calculation.

The uplink path loss may be obtained through calculation according to the following equation:

PL_{PUCCH/PUSCH/SRS}^{dB}=TxPower_{PUCCH/PUSCH/SRS}^{dB}−PSD_{RX}^{Linear}(PUCCH_DMRS/PUSCH_DMRS/SRS),

where PL_{PUCCH/PUSCH/SRS}^{dB} represents an uplink path loss of the PUCCH/PUSCH/SRS signal transmitted by the mobile terminal UE to the low power node LPN, which is counted by dBs; TxPower_{PUCCH/PUSCH/SRS}^{dB} represents transmission power of the mobile terminal UE at the time of transmitting the PUCCH/PUSCH/SRS signal, which is counted by dBs; and PSD_{RX}^{Linear}(PUCCH_DMRS/PUSCH_DMRS/SRS) represents linearly-detected received power of the PUCCH/PUSCH/SRS transmitted from the LPN to the mobile terminal UE.

The transmission power TxPower_{PUCCH/PUSCH/SRS}^{dB} of the mobile terminal UE transmitting the uplink signal may be estimated by the macro base station. Specifically, during communications between the macro base station BS and the mobile terminal UE, the terminal UE reports, to the macro base station BS, receiving quality information for the downlink signal of the macro base station BS, and the macro base station BS obtains a downlink path loss from the macro base station BS to the mobile terminal UE through calculation according to the transmission power of the downlink signal thereof and the received quality of the terminal, so as to estimate the uplink path loss from the macro base station BS to the mobile terminal UE according to reciprocity of the downlink path and the uplink path. Further, the macro base station BS may obtain transmission power TxPower_{PUCCH/PUSCH/SRS}^{dB} of the mobile terminal UE transmitting the uplink signal according to the received quality of the uplink signal of the mobile terminal UE and the estimated uplink path loss.

On the other hand, for the transmission power TxPower_{PUCCH/PUSCH/SRS}^{dB} of the mobile terminal UE transmitting the uplink signal, the uplink transmission power may also be required, by the macro base station BS, to be reported by a mobile terminal UE satisfying conditions, thereby obtaining the uplink path loss of the low power node LPN through calculation according to the foregoing equation.

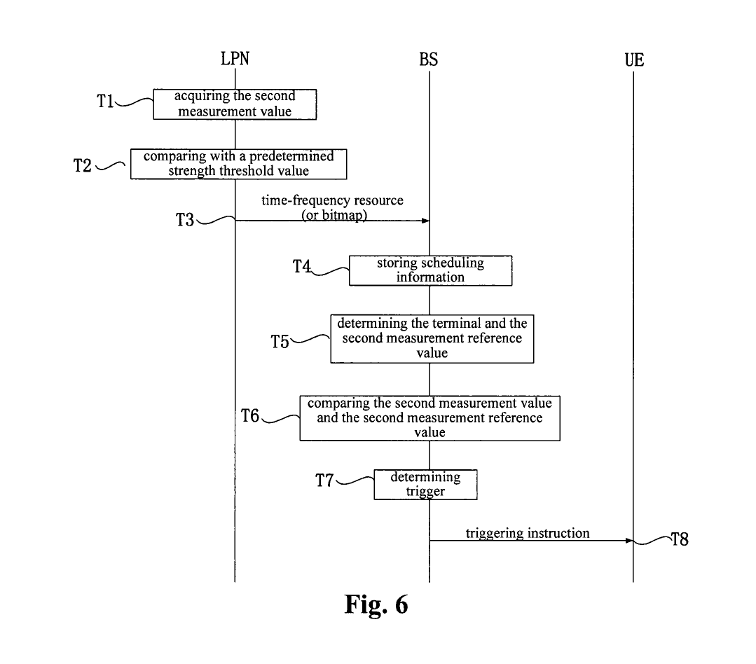

Hereinafter, an example of implementing the method as shown in FIG. 5 will be described in detail in combination with the timing diagrams according to FIGS. 6 through 8. FIGS. 6 through 8 are examples where no common baseband is shared by the small cell base station LPN and the macro base station BS.

FIG. 6 is a timing diagram illustrating a specific example of the method as shown in FIG. 5 according to an embodiment of the disclosure. As shown in FIG. 6, at time T1, the small cell base station LPN receives uplink signals from the mobile terminal UE of the macro base station BS on the component carrier CC1, thereby obtaining the strength of at least one of the uplink signals as the second measurement value. After the LPN obtains the second measurement value, the second measurement value may be transmitted to the macro base station BS based on settings according to a predetermined time period. Alternatively, the second measurement value may also be transmitted to the macro base station BS when a predetermined condition is satisfied in subsequent process. The example as shown in FIG. 6 is the latter case. It should be noted herein that in the case of common baseband, the information may be shared directly without additional transmission.

At time T2, the small cell base station LPN compares the obtained second measurement value with its predetermined strength threshold value. The predetermined strength threshold value is set to be not greater than the second measurement reference value to be used in subsequent process.

When the second measurement value is greater than the predetermined strength threshold value, at time T3 the small cell base station LPN transmits time-frequency resource location information corresponding to the detected signal strength to the macro base station BS. Or, alternatively, the small cell base station LPN may periodically transmit resource bitmap information to the macro base station BS. A mark of a corresponding resource block in the resource bitmap indicates whether or not the signal strength on the resource block which serves as the second measurement value is higher than the predetermined strength threshold value. In addition, if the second measurement value has not yet been transmitted to the macro base station BS, the second measurement value may also be transmitted to the macro base station BS after it is determined that the second measurement value is greater than the predetermined strength threshold value (not shown in the figure).

At time T4, the macro base station BS starts to store scheduling information for the terminal UE located near the small cell base station LPN, according to the location of the terminal of the macro base station BS, in response to the time-frequency resource location information from the small cell base station LPN, the mark existing in the resource bitmap information which indicates that the signal strength is higher than the predetermined strength threshold value, or only the second measurement value. The location information of the mobile terminal may be acquired using various known methods. For example, the mobile terminal is located using a global positioning system (GPS). Or, for example, an approximate location of the mobile terminal is determined according to an arrival angle and a time advance amount of uplink data of the mobile terminal. The scheduling information stored by the macro base station BS may contain at least one of scheduled user information, uplink power control information of the scheduled user, and scheduled resource location information. Specific transmission contents may be at least one of an uplink sounding reference signal, a physical uplink control channel signal and a physical uplink share channel signal.

Due to no common baseband, the small cell base station LPN and the macro base station BS transmit information via an X2 interface, thus causing a time delay of tens of milliseconds. After time T4, the macro base station BS will receive the information related to the time-frequency resources which is transmitted by the small cell base station LPN after time T3 (not shown in the figure). At time T5, the macro base station BS may determine a terminal, that is, determine an object for which inter-frequency measurement is to be triggered, in response to the information related to the time-frequency resources which is subsequently transmitted by the small cell base station LPN.

At time T6, the second measurement and the second measurement reference value are compared to determine whether or not the second measurement value has offset from the second measurement reference value by a predetermined offset amount. When the comparison result is that the second measurement value has offset by a predetermined offset amount, a decision of triggering inter-frequency measurement of the mobile terminal is made at time T7. Besides, at time T8, an indication of performing inter-frequency measurement is transmitted to the mobile terminal UE. As should be understood by those skilled in the art, the timing diagram and the relevant descriptions belong only to a specific embodiment of the invention, and the invention is not limited to the above timing sequence. For example, the step of determining the mobile terminal for which inter-frequency measurement is to be triggered may also be performed after the decision of triggering inter-frequency measurement is made.

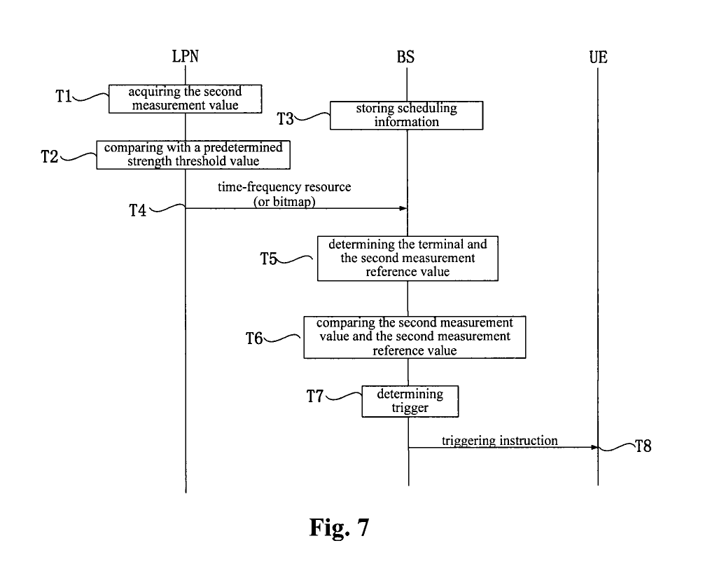

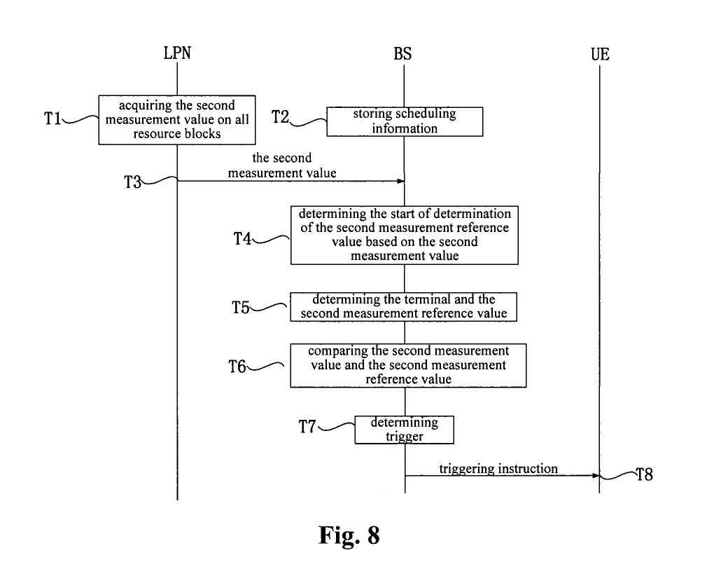

FIGS. 7 and 8 are timing diagrams illustrating other examples of a method as shown in FIG. 5 according to an embodiment of the disclosure, respectively. Hereinafter, only differences of the examples as shown in FIGS. 7 and 8 from the example as shown in FIG. 6 will be described.

The difference of the example as shown in FIG. 7 from the example as shown in FIG. 6 lies in that, in a case where it is unnecessary to receive the information related to the time-frequency resources from the small cell base station LPN, the macro base station BS initiatively stores the scheduling information of the mobile terminal UE near the small cell base station LPN according to the location information of the mobile terminal UE thereof. As compared with the example as shown in FIG. 6, the example as shown in FIG. 7 has the following advantage: upon receipt of the information related to the time-frequency resources and second measurement information, determination of the terminal and corresponding second measurement reference information may be performed immediately, without waiting storage of the scheduling information and reception of the next time-frequency resource information. Alternatively, the macro base station BS may store terminal scheduling information on all resource blocks of a previous particular number of frames.

The difference of the example as shown in FIG. 8 from the example as shown in FIG. 7 lies in that, no comparison between the second measurement value and the predetermined strength threshold value is performed at the small cell base station LPN, and the small cell base station LPN transmits, to the macro base station BS, its own measurement result for the signal strength serving as the second measurement value on all the resource blocks, so that the macro base station may determine whether or not a decision of triggering inter-frequency measurement of the mobile terminal is made and determine a mobile terminal to be triggered. As compared with the examples as shown in FIGS. 6 and 7, the example as shown in FIG. 8 has an advantage of reducing the reconstruction of the small cell base station and the reconstruction cost.

In a case of a common baseband shared by the small cell base station LPN and the macro base station BS, the baseband maintains basic scheduling information of the previous frame. Thus, in one embodiment of a common baseband shared by the small cell base station LPN and the macro base station BS, inter-frequency triggering measurement may be performed according to the method as shown in FIG. 5, without individually performing steps such as storage of scheduling information and so on.

Similarly to the case of determining CC2 inter-frequency measurement according to downlink CC1 signals, in the case of determining CC2 inter-frequency measurement according to uplink CC1 signals, the predetermined offset amount may be determined based on an inter-frequency measurement triggering target accuracy rate, which is a probability that an inter-frequency small cell signal strength detected after the triggering of the inter-frequency measurement is higher than a particular target threshold value. In other words, the setting of the predetermined offset amount shall ensure that the detected inter-frequency small cell signal strength is high enough after inter-frequency measurement is triggered.

In the foregoing embodiments, inter-frequency measurement may be triggered when the offset of the second measurement value from the second measurement reference value exceeds the predetermined offset amount. It should be understood that a predetermined condition may also be further set, such that inter-frequency measurement is triggered only when the second measurement value offsets from the second measurement reference value by a predetermined offset amount to satisfy the predetermined condition. The predetermined condition may comprise at least one of a duration in which the offset amount is higher than or lower than the predetermined offset amount is longer than a predetermined time length, and a frequency of occurrence of the offset amount being higher than or lower than the predetermined offset amount within a predetermined period of time is greater than a predetermined number of times or percentage. Similarly, the predetermined condition may also be determined based on an inter-frequency measurement triggering target accuracy rate, which is a probability that an inter-frequency small cell signal strength detected after the triggering of the inter-frequency measurement is higher than a particular target threshold value.

Determination Based on a Combination of CC1 Uplink and Downlink Measurement Results

Since the methods of determining triggering of CC2 inter-frequency measurement according to CC1 downlink and uplink measurement results have been described above in detail respectively, those skilled in the art would design various combined manners of determining triggering of CC2 inter-frequency measurement according to CC1 downlink and uplink measurement results based on practical requirements, without exercise of any inventive skill, which will not be described by way of examples in detail herein.

Hereinafter, the structure and the function of a wireless communication apparatus for implementing the wireless communication method according to the disclosure will be described in detail.

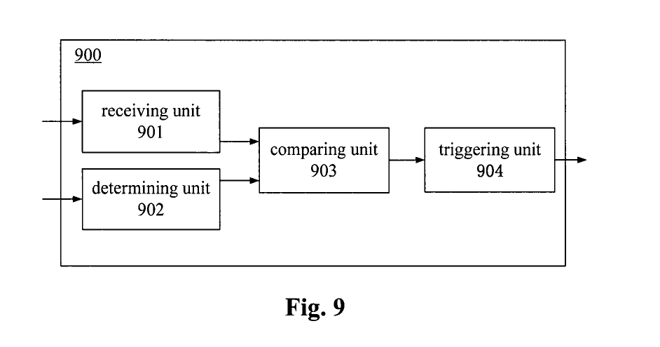

FIG. 9 is a function structural block diagram illustrating a wireless communication apparatus 900 according to an embodiment of the disclosure. The wireless communication apparatus 900 comprises a receiving unit 901, a determining unit 902, a comparing unit 903 and a triggering unit 904.

The receiving unit 901 receives a measurement value of a receiving signal of a terminal, or receives a measurement value of a signal received by a small cell base station from a terminal. For the sake of convenience, the measurement value of the receiving signal of the terminal is referred to as a first measurement value, and the measurement value of the signal received by the small cell base station from the terminal is referred to as a second measurement value. The first measurement value for example at least comprises one of reference signal receiving power, reference signal receiving quality, reference signal strength indication, channel quality/channel state indication, reference signal receiving power based on the channel quality/channel state indication, and reference signal receiving quality based on the channel quality/channel state indication. The second measurement value is, for example, the signal strength of at least one of an uplink sounding reference signal, a physical uplink control channel signal and a physical uplink share channel signal received by the small cell base station on uplink service carriers of the terminal.

The determining unit 902 determines, as a first/second measurement reference value, a statistic value of quality information which is associated with the location of the terminal and is corresponding to the first/second measurement value, or an average value thereof.

In the operating mode in which determination is performed for triggering of inter-frequency measurement of the CC2 through downlink signals on the service carriers CC1, the determining unit 902 is configured to acquire quality information required for determining the first measurement reference value which is associated with the location of the terminal and is corresponding to the first measurement value, in a case where the small cell base station is closed, or in a case where the small cell base station only performs uplink reception on the service carriers of the terminal without performing downlink transmission.

In an alternative embodiment, the wireless communication apparatus 900 may further comprise an adjacency determining unit (not shown). The adjacency determining unit may determine, according to the location of the terminal, whether or not the terminal is adjacent to the second base station which can support service carrier data transmission and other carrier data transmission of the terminal. In the embodiment, the determining unit 902 may be configured to determine the first measurement reference value according to a current location of the terminal, in a case where the adjacency determining unit determines that the terminal is adjacent to the second base station which can support service carrier data transmission and other carrier data transmission of the terminal.

In the operating mode in which determination is performed for triggering of inter-frequency measurement of the CC2 through uplink signals on the service carriers CC1, the determining unit is configured to determine, as the second measurement reference value, a statistic value of the signal strength of at least one of the uplink sounding reference signal, the physical uplink control channel signal and the physical uplink share channel signal of the terminal located at a coverage radius edge of the small cell base station on the service carriers CC1, or an average value thereof, in response to a resource detection result from the small cell base station. In a preferred embodiment, the wireless communication apparatus 900 may further comprise a storing unit (not shown). The storing unit may be configured to store scheduling information of the terminal located near the small cell base station according to the location information of the terminal, or to store terminal scheduling information on all resource blocks of a previous particular number of frames.

The comparing unit 903 compares the first/second measurement value received by the receiving unit 901 with the first/second measurement reference information determined by the determining unit 902, so as to determine an offset amount between the first/second measurement value and the first/second measurement reference value. The triggering unit 904 determines, according to a relationship of a predetermined offset amount and an offset amount between the first measurement value and the first measurement reference value which is determined by the comparing unit, whether to trigger inter-frequency measurement of the terminal.

In the operating mode in which determination is performed for triggering of inter-frequency measurement of the CC2 through downlink signals on the service carriers CC1, when the small cell base station and the macro base station do not simultaneously transmit downlink signals on service carriers of the terminal, inter-frequency measurement of the terminal is triggered when the first measurement value is higher than or lower than the first measurement reference value by an amount less than a predetermined offset amount, i.e. when the offset amount between the first measurement value and the first measurement reference value does not greatly differ from the predetermined offset amount. When the small cell base station and the macro base station simultaneously transmit downlink signals on service carriers of the terminal, the triggering unit 904 may be configured to trigger inter-frequency measurement of the terminal when the first measurement value is higher than the first measurement reference value by an amount more than the predetermined offset amount, when cell identifiers of downlink signal sequences transmitted by a small cell and a macro cell on the same service carrier are the same, and to trigger inter-frequency measurement of the terminal when the first measurement value is lower than the first measurement reference value by an amount more than the predetermined offset amount, when the cell identifiers of the downlink signal sequences transmitted by the small cell and the macro cell on the same service carrier are different.

In the operating mode in which determination is performed for triggering of inter-frequency measurement of the CC2 through uplink signals on the service carriers CC1, the triggering unit 904 may be configured to trigger inter-frequency measurement of the terminal when it is at least satisfied that the second measurement value is higher than the difference of the second measurement reference value minus the predetermined offset amount.

In addition, as stated above, when transmission power of the mobile terminal UE is very large, although the mobile terminal UE is very far from the small cell base station, a case where the predetermined offset amount and the offset amount between the second measurement value and the second measurement reference value satisfy the above condition of triggering inter-frequency measurement still would possibly occur, while actually it is not yet needed to perform inter-frequency measurement. In this case, as a preferred embodiment, inter-frequency measurement of the terminal may be triggered further according to an uplink path loss. Specifically, the triggering unit 904 may be configured to trigger inter-frequency measurement of the terminal, when it is satisfied that the uplink path loss of the signal received by the small cell base station from the mobile terminal UE is lower than the statistic value of the uplink path loss of the edge terminal user of the small cell base station plus the predetermined offset amount. Also as stated above, the scheme of triggering inter-frequency measurement according to the uplink path loss may also be adopted individually by the triggering unit 904 to reduce the complexity of calculation.

As stated above in describing the wireless communication method according to the disclosure, the predetermined offset amount may be determined based on an inter-frequency measurement triggering target accuracy rate, which is a probability that an inter-frequency small cell signal strength detected after the triggering of the inter-frequency measurement is higher than a first target threshold value.

In a further embodiment, the triggering unit may be configured to trigger inter-frequency measurement of the terminal, in a case where the relationship of the predetermined offset amount and the offset between the first/second measurement value and the first/second measurement reference value satisfies a predetermined condition. The predetermined condition comprises at least one of duration and occurrence frequency. The predetermined condition is, for example, a duration in which the predetermined offset amount and the offset amount between the first measurement value and the first measurement reference value satisfy the predetermined relationship is longer than a predetermined time length, or a frequency of occurrence of satisfying the predetermined relationship within a predetermined period of time is greater than a predetermined number of times or percentage. Similarly, the predetermined condition may also be determined based on an inter-frequency measurement triggering target accuracy rate, which is a probability that an inter-frequency small cell signal strength detected after the triggering of the inter-frequency measurement is higher than a second target threshold value, wherein the second target threshold may be the same as or different from the first target threshold.

An example of the wireless communication apparatus 900 is for example a macro base station BS. Of course, the wireless communication apparatus 900 may also be an apparatus independent upon a base station as long as it can implement the above function. For the operating flow of the wireless communication apparatus 900, reference is made to the foregoing descriptions of the wireless communication method according to the disclosure.

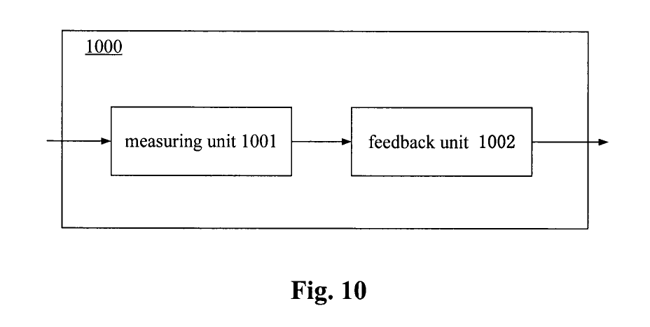

FIG. 10 is a function structural block diagram illustrating another wireless communication apparatus 1000 according to an embodiment of the disclosure.

The wireless communication apparatus comprises a measuring unit 1001 and a feedback unit 1002. The measuring unit 1001 acquires a measurement value of a signal received from a non-service terminal. The measurement value is, for example, the signal strength of at least one of an uplink sounding reference signal, a physical uplink control channel signal and a physical uplink share channel signal received on service carriers of the non-service terminal.

The feedback unit 1002 provides the measurement value and information associated with the measurement value to a service base station of the non-service terminal.

In one embodiment, the feedback unit 1002 is configured to provide measurement values obtained on all resource blocks of its own to a service base station.

In another embodiment, the wireless communication apparatus 1000 may further comprise a comparing unit (not shown). The comparing unit may compare the signal strength serving as the measurement value with the predetermined strength threshold value. The predetermined strength threshold value may be preset as appropriate. When the signal strength is greater than the predetermined strength threshold value, the feedback unit 1002 provides time-frequency resource location information corresponding to the measured signal strength, as information associated with the measurement value, to the service base station.

In a further embodiment, the comparing unit compares the signal strength serving as the measurement value with the predetermined strength threshold value, while the feedback unit 1002 periodically transmits resource bitmap information to the service base station. A mark of a corresponding resource block in the resource bitmap indicates whether or not a signal strength on the resource block which serves as the measurement value is higher than the predetermined strength threshold value.

An example of the wireless communication apparatus 1000 is for example a small cell base station LPN. Of course, the wireless communication apparatus 1000 may also be an apparatus independent upon a base station as long as it can implement the above function. For the operating flow of the wireless communication apparatus 1000, reference is made to the foregoing descriptions of the wireless communication method according to the disclosure.

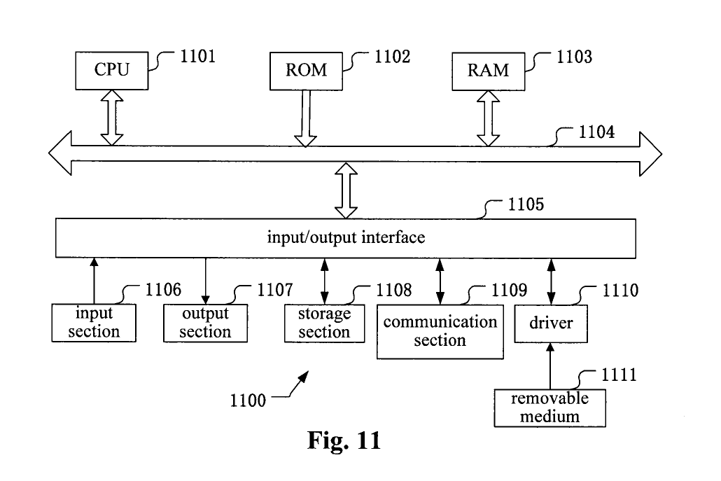

FIG. 11 is a schematic block diagram that can be used for implementing the wireless communication apparatus according to the embodiment of the invention.

In FIG. 11, a Central Processing Unit (CPU) 1101 performs various processes in accordance to a program stored in a Read-Only Memory (ROM) 1102 or a program uploaded from a storage section 1108 to a Random Access Memory (ARM) 1103. In the RAM 1103, data required when the CPU 1101 performs various processes and so on is also stored as appropriate. The CPU 1101, the CPU 1102 and the RAM 1103 are connected to each other via a bus 1104. An input/Output interface 1105 is also connected to the bus 1104.

The following components are connected to the input/output interface 1105: an input section 1106 (including a keyboard, a mouse, etc.), an output section 1107 (including a display such as a Cathode Ray Tube (CRT), a Liquid Crystal Display (LCD) and so on, a loudspeaker, etc.), a storage section 1108 (including hard disc, etc.), and a communication section 1109 (including a network interface card such as an LAN card, a modem, etc.). The communication section 1109 performs communication process over a network such as the Internet. According to practical requirements, the driver 1110 can also be connected to the input/output interface 1105. A removable medium 1111 such as a magnetic disc, a compact disc, a magneto-optical disc, a semiconductor memory and so on is installed to the driver 1110 as appropriate, such that a computer program read therefrom is installed to the storage section 1108 as appropriate.

In a case where the above series of processes are performed by means of software, a program constituting the software is installed from a network such as the Internet or a storage medium such as the removable medium 1111.

As should be understood by those skilled in the art, such a storage medium is not limited to the removable medium 1111 as shown in FIG. 11 which stores a program and is distributed separately from a device to provide a user with the program. Examples of the removable medium 1111 include a magnetic disc (including a floppy disc (registered trademark)), a compact disc (including a Compact Disc Read-Only-Memory (CD-ROM) and a Digital Versatile Disc (DVD)), a magneto-optical disc (including a Mini Disc (MD) (registered trademark)) and a semiconductor memory. Or, the storage medium may be ROM 1102, a hard disc included in the storage section 1108 and the like, which store programs and are distributed to users together with devices containing them.

When the instruction code is read and executed by a machine, the method for use in the wireless communication system according to the embodiment of the invention can be implemented.

For those ordinarily skilled in the art, numerous variants and modifications apparently can be made without departing from the scope and the spirit of the invention. The selections and the descriptions for the embodiments aim to better explain the principle and the practical application of the invention, so as to make those ordinarily skilled in the art to understand that the invention can have various embodiments with various variants which are adapted for desired specific uses.

1-15. (canceled)

16. A wireless communication apparatus, for use in a heterogeneous network comprising a first base station and a second base station with different transmission power levels, the wireless communication apparatus comprising:
a receiving unit, for receiving a measurement value of a signal received by a terminal as a first measurement value, or receiving a measurement value of a signal received by the second base station from the terminal as a second measurement value;
a determining unit, for determining, as a first/second measurement reference value, a statistic value of quality information which is associated with a location of the terminal and is corresponding to the first/second measurement value;
a comparing unit, for comparing the first/second measurement value with the first/second measurement reference value; and
a triggering unit, for triggering inter-frequency measurement of the terminal according to a relationship of a predetermined offset amount and an offset of the first/second measurement value from the first/second measurement reference value.

17. The wireless communication apparatus according to claim 16, wherein, the first measurement value at least comprises one of reference signal receiving power, reference signal receiving quality, reference signal strength indication, channel quality/channel state indication, reference signal receiving power based on the channel quality/channel state indication, and reference signal receiving quality based on the channel quality/channel state indication.

18. The wireless communication apparatus according to claim 17, wherein, the determining unit is configured to obtain the first measurement reference value from the first measurement value which is acquired by the terminal when not being influenced by the signal of the second base station.

19. The wireless communication apparatus according to claim 18, wherein, the triggering unit is configured to trigger inter-frequency measurement of the terminal when the first measurement value is higher or lower than the first measurement reference value by an amount less than a predetermined offset amount, when the second base station and the first base station do not simultaneously transmit downlink signals on service carriers of the terminal.

20. The wireless communication apparatus according to claim 17, further comprising an adjacency determining unit for determining, according to the location of the terminal, whether or not the terminal is adjacent to the second base station which can support service carrier data transmission and other carrier data transmission of the terminal;
wherein the determining unit is configured to determine the first measurement reference value according to a current location of the terminal, in a case where it is determined that the terminal is adjacent to the second base station which can support service carrier data transmission and other carrier data transmission of the terminal.

21. The wireless communication apparatus according to claim 20, wherein, the triggering unit is configured to:
trigger inter-frequency measurement of the terminal when the first measurement value is higher than the first measurement reference value by an amount more than the predetermined offset amount, when cell identifiers of downlink signal sequences transmitted by a cell of the second base station and a cell of the first base station on the service carriers of the terminal are the same as each other; and
trigger inter-frequency measurement of the terminal when the first measurement value is lower than the first measurement reference value by an amount more than the predetermined offset amount, when the cell identifiers of the downlink signal sequences transmitted by the cell of the second base station and the cell of the first base station on the service carriers of the terminal are different from each other.

22. The wireless communication apparatus according to claim 16, wherein, the second measurement value corresponds to a signal strength of at least one of an uplink sounding reference signal, a physical uplink control channel signal and a physical uplink share channel signal received by the second base station on uplink service carriers of the terminal.

23. The wireless communication apparatus according to claim 22, wherein, the determining unit is configured to determine, in correspondence to the second measurement value, a statistic average value of the signal strength of at least one of the uplink sounding reference signal, the physical uplink control channel signal and the physical uplink share channel signal of the terminal located at a coverage radius edge of the second base station on the service carriers, as the second measurement reference value.

24. The wireless communication apparatus according to claim 23, wherein, the triggering unit is configured to trigger inter-frequency measurement of the terminal when it is at least satisfied that the second measurement value is higher than the difference of the second measurement reference value minus the predetermined offset amount.

25. The wireless communication apparatus according to claim 16, wherein, the triggering unit is configured to trigger inter-frequency measurement of the terminal according to a relationship between an uplink path loss estimated from the signal received by the second base station from the terminal and a statistic value of an uplink path loss of an edge terminal user of the second base station.

26. The wireless communication apparatus according to claim 16, wherein, the predetermined offset amount is determined based on an inter-frequency measurement triggering target accuracy rate, which is a probability that an inter-frequency signal strength of the cell of the second base station detected after the triggering of inter-frequency measurement is higher than a first target threshold value.

27. The wireless communication apparatus according to claim 16, wherein, coverage areas of the first base station and the second base station are adjacent to or overlap with each other, and the signal received by the terminal is a signal received on service carriers of the first base station.

28-30. (canceled)

31. A wireless communication method allowing triggering of inter-frequency measurement, for use in a heterogeneous network comprising a first base station and a second base station with different transmission power levels, the wireless communication method comprising:
receiving a measurement value of a signal received by a terminal as a first measurement value, or receiving a measurement value of a signal received by the second base station from the terminal as a second measurement value;
determining a first/second measurement reference value of a statistic value of quality information which is associated with a location of the terminal and is corresponding to the first/second measurement value;
comparing the first/second measurement value with the first/second measurement reference value; and
triggering an inter-frequency measurement of the terminal according to a relationship of a predetermined offset amount and an offset of the first/second measurement value from the first/second measurement reference value.

32. A wireless communication apparatus, for use in a heterogeneous network comprising a first base station and a second base station with different transmission power levels, comprises:
circuitry configured to
receive a measurement value of a signal received by a terminal as a first measurement value;
determine, as a first measurement reference value, a statistic value of quality information which is associated with a location of the terminal and is corresponding to the first measurement value;
compare the first measurement value with the first measurement reference value; and
trigger an inter-frequency measurement of the terminal according to a relationship of a predetermined offset amount and an offset of the first measurement value from the first measurement reference value.

33. A wireless communication apparatus, for use in a heterogeneous network comprising a first base station and a second base station with different transmission power levels, the wireless communication apparatus comprising:
circuitry configured to
receive a measurement value of a signal received by the second base station from a terminal as a second measurement value;
determine, as a second measurement reference value, a statistic value of quality information which is associated with a location of the terminal and is corresponding to the second measurement value;
compare the second measurement value with the second measurement reference value; and
trigger an inter-frequency measurement of the terminal according to a relationship of a predetermined offset amount and an offset of the second measurement value from the second measurement reference value.

34. A terminal device, for use in a heterogeneous network comprising a first base station and a second base station with different transmission power levels, comprises:
circuitry configured to
transmit a measurement value of a signal as a first measurement value to the first base station;
conduct an inter-frequency measurement based on a measurement triggering indication from the first base station according to a relationship of a predetermined offset amount and an offset of the first measurement value from a first measurement reference value,
wherein a statistic value, of quality information which is associated with a location of the terminal device and is corresponding to the first measurement value, is determined as the first measurement reference value.

35. The terminal device according to claim 34, wherein, the first measurement value at least comprises one of reference signal receiving power, reference signal receiving quality, reference signal strength indication, channel quality/channel state indication, reference signal receiving power based on the channel quality/channel state indication, and reference signal receiving quality based on the channel quality/channel state indication.

36. The terminal device according to claim 35, wherein, the first measurement reference value is determined based on the first measurement value when not being influenced by the signal of the second base station.

37. The terminal device according to claim 34, wherein, the predetermined offset amount is determined based on an inter-frequency measurement triggering target accuracy rate, which is a probability that an inter-frequency signal strength of the cell of the second base station detected after the triggering of inter-frequency measurement is higher than a first target threshold value.

38. The terminal device according to claim 34, wherein, coverage areas of the first base station and the second base station are adjacent to or overlap with each other, and the signal is a signal received on service carriers of the first base station.
